(19) United States
(12) Patent Application Publication
(10) Pub. No.: US 2012/0003493 A1
(43) Pub. Date: Jan. 5, 2012

(54) Composite Component and Method for the Production Thereof

(75) Inventors: Klaus Schon, (US); Jacques Pirlet, (US); Robert Koenig, Creuben (DE); Dirk Heesen, Duisberg (DE); Bernhard Schuetter, Muhlheim/Ruhr (DE); Leon Simmen, Brugg (CH); Beat Hofer, Derendingen (CH)

(73) Assignee: Kennametal Inc., Latrobe, PA (US)

(21) Appl. No.: 13/053,369

(22) Filed: Mar. 22, 2011

(30) Foreign Application Priority Data
Apr. 9, 2010 (DE) 10 2010 014 303.0

(51) Int. Cl. B32B 15/04; B22F 7/08

(52) U.S. Cl. 428/548; 419/8

(57) ABSTRACT

The invention relates to a composite component (10) having a carrier (12) made of powder metal and a wear-resistant body (14) which is made of cemented carbide and is embedded at least in certain portions in the carrier (12), wherein the cemented carbide body (14) is metalized at least in certain portions. The invention also relates to a method for producing such a composite component.

The invention relates to a composite component having a carrier made of powder metal and a wear-resistant body which is made of cemented carbide and is embedded at least in certain portions in the carrier. The invention also relates to a method for producing such a composite component.

Such a composite component can be used, for example, for rolling steel. The hardness of the cemented carbide body means that the latter is extremely wear-resistant, and therefore high service lives are obtained. The carrier has the toughness required in order to be able to reliably absorb the stresses which occur with a high service life. An example of such a composite component can be found in DE 43 21 143 A1.

The object of the invention is to develop the known composite component to the effect that a better bond is provided between the carrier and the cemented carbide body.

In order to achieve this object, the invention provides for the cemented carbide body to be metalized at least in certain portions. It has emerged that the use of a metalization on the cemented carbide body provides an improved metallurgical bond between the cemented carbide body and the carrier as a result of diffusion.

According to a preferred embodiment of the invention, the metalization consists of nickel. It has emerged that nickel has a particularly advantageous effect on the diffusion processes.

Alternatively, the metalization can also consist of copper or chromium.

In order to achieve the object mentioned above, the invention also provides a method for producing a composite component by means of the following steps: firstly, a wear-resistant body made of cemented carbide is provided. Then, a metal layer is provided on the cemented carbide body. Then, the cemented carbide body is embedded in metal powder together with the metal layer. Thereafter, the metal powder is subjected to hot isostatic pressing together with the cemented carbide body. The thin metal layer on the cemented carbide body, which layer can consist of nickel, for example, improves the metallurgical bond between the cemented carbide body and the carrier.

According to one embodiment of the invention, the cemented carbide body is coated by electrodeposition. This makes it possible to apply a metalization having the desired layer thickness with little outlay.

In principle, it may also be provided for the metal layer to be provided in the form of a foil or thin plate arranged between the cemented carbide body and the metal powder. During the hot isostatic pressing, the material of the metal layer assists the diffusion processes which lead to a good metallurgical bond between the cemented carbide and the carrier.

Advantageous configurations of the invention are apparent from the dependent claims.

In the text which follows, the invention is described on the basis of an embodiment which is shown in the appended drawings, in which:

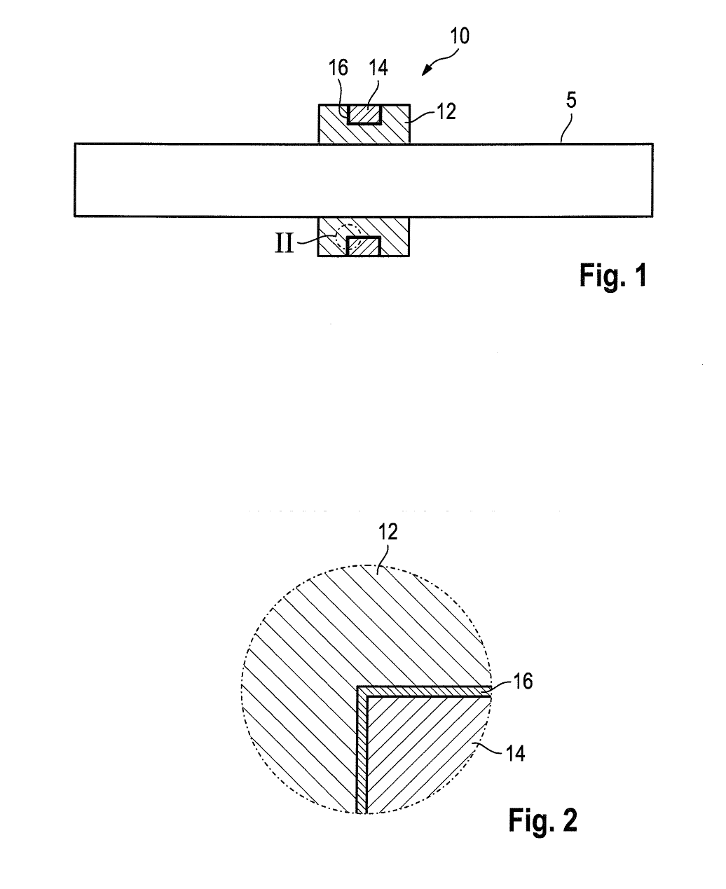

FIG. 1 schematically shows a composite component according to the invention arranged on a shaft;

FIG. 2 shows the detail II from FIG. 1 on an enlarged scale; and

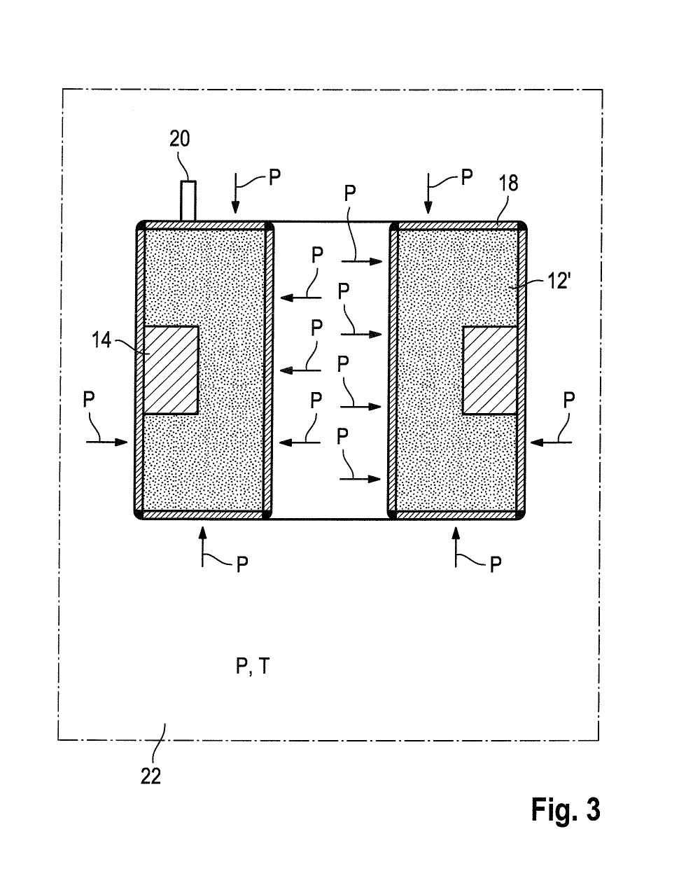

FIG. 3 schematically shows the production of the composite component.

FIG. 1 schematically shows a shaft 5, on which a composite component 10 according to the invention is arranged. The exemplary embodiment shown is a roll used for the production of steel. However, the composite component according to the invention can be used in a multiplicity of applications. Therefore, the description which follows is to be understood merely as the exemplary illustration of an application.

The composite component comprises a carrier 12 and a wear-resistant body 14. As can be seen more clearly in FIG. 2, there is a metal layer 16 between the carrier 12 and the wear-resistant body 14.

The carrier 12 consists of powder metal, preferably of an alloyed high-quality structural steel which is tough at low temperatures. One example is material 1.6957. Other heat-treated steels and also high-strength, stainless steels are also suitable, however.

The wear-resistant body 14 consists of cemented carbide, in particular of WC with a binder proportion of Co, NiCr, CoNiFe or CoNiCr. Depending on the application, it is also possible to use cemented carbides with additional carbides.

Here, the cemented carbide body 14 is shown merely by way of example as a ring with a simple rectangular cross section. In principle, other cross-sectional shapes are also suitable. In particular, the outer side of the ring may have profiled sections which result from the respective application. It is also possible to only form a profiled section on the outer side retroactively.

The metal layer 16 preferably consists of nickel. It can be applied as a metalization by electrodeposition, for example. In this case, the thickness of the nickel metalization applied by electrodeposition is in the order of magnitude of 10 to 20 μm. However, the metal layer can also be applied in a different manner. One example is a metal layer applied by thermal spraying. Alternatively, it is also possible to introduce the metal layer 16 as an originally separate component in the form of a foil or thin plate.

In principle, the metal layer 16 is only provided in those regions in which the cemented carbide body 14 is subsequently surrounded by the powder metal carrier 12. However, it is not necessary to limit the presence of the metal layer 16 to these regions. It causes no harm if the metal layer 16 is also present on the outer side of the annular cemented carbide body 14. This will mostly be the case, in particular, when a metalization is applied by electrodeposition.

In order to produce the composite component, the cemented carbide body 14 is encapsulated together with the metal layer 16 by the steel 12′ present in powder form, and arranged in a mold 18 which, in the present case, is designed as a steel capsule. The mold 18 may be formed from steel plates, for example, which are welded to one another. This mold is used to subject the steel 12′ present in powder form to hot isostatic pressing. For this purpose, the interior of the mold is firstly evacuated by means of a nozzle 20 provided on the mold 18. Then, the mold is arranged in a pressure chamber 22, in which it is exposed to the required pressures and the required temperature, which act uniformly from all sides (see the arrows P).

The hot isostatic pressing begins with a slow heating phase, followed by a holding phase during which temperatures in the order of magnitude of 900° C. to 1300° C. and also pressures in the range of 1000 to 2000 bar prevail. Depending on the materials used, the duration of the holding phase is between 1 and 9 hours. The holding phase is followed by a slow cooling phase.

Once the hot isostatic pressing has been completed, the pulverulent steel 12′ is sintered to form a carrier 12 made of powder metal, whereas the cemented carbide body 14 has essentially undergone no metallurgical change. In the powder metal of the carrier 12, the nickel of the metal layer 16 has formed a diffusion layer having a thickness of up to 0.5 mm, which results in a particularly good bond between the powder metal carrier 12 and the cemented carbide body 14. Depending on the method parameters, the diffusion layer has a thickness in the order of magnitude of 70 to 90 μm, but this thickness may also reach up to 500 μm. A significant increase in hardness can be seen in the diffusion zone.

Once the hot isostatic pressing has been completed, the mold 18 is removed. In this respect, it may be advantageous if the metal layer 16 was also provided on the outer side of the annular cemented carbide body 14, since this can make it easier to separate the steel plates of the mold 18 from the cemented carbide body 14.

A particular advantage of the hot isostatic pressing used for the production of the composite component is that the cemented carbide body 14 is recompressed again during the hot isostatic pressing.

1. A composite component having a carrier comprising powder metal and a wear-resistant body comprising cemented carbide and embedded at least in certain portions in the carrier, wherein the wear-resistant body is metalized at least in certain portions.

2. The composite component as claimed in claim 1, wherein the metalization comprises nickel.

3. The composite component as claimed in claim 1, wherein the metalization comprises copper.

4. The composite component as claimed in claim 1, wherein the metalization comprises chromium.

5. The composite component as claimed in claim 1, wherein the wear-resistant body comprises WC with a binder proportion of Co, NiCr, CoNiFe or CoNiCr.

6. The composite component as claimed in claim 1, wherein the carrier comprises an alloyed high-quality structural steel.

7. The composite component as claimed in claim 1, wherein the composite component is in the form of a composite roll for the production of steel.

8. A method for producing a composite component comprising the following steps:
providing a wear-resistant body comprising cemented carbide;
providing a thin metal layer on the wear-resistant body;
embedding the wear-resistant body in metal powder; and
subjecting the metal powder to hot isostatic pressing together with the wear-resistant body.

9. The method as claimed in claim 8, wherein the wear-resistant body is coated by electrodeposition.

10. The method as claimed in claim 8, wherein the wear-resistant body is coated on all sides.

11. The method as claimed in claim 8, wherein the thickness of the metal layer is between 10 μm and 5 mm.

12. The method as claimed in claim 8, wherein the hot isostatic pressing produces a diffusion layer in the carrier which has a thickness of about 0.5 mm and is distinguished by a considerable increase in hardness.

13. The method as claimed in claim 8, wherein the hot isostatic pressing includes a heating phase, a holding phase and a cooling phase, where a temperature in the range of 900 to 1300° C. is present during the holding phase.

14. The method as claimed in claim 13, wherein the duration of the holding phase is between 1 h and 9 h.

15. The method as claimed in claim 13, wherein pressures in the range of 1000 to 2000 bar prevail during the holding phase.

16. The composite component as claimed in claim 1, wherein the thickness of the metallization is between 10 μm and 5 mm.

17. The composite component as claimed in claim 1, wherein the thickness of the metallization is between 70 μm and 90 μm.

18. The composite component as claimed in claim 1, wherein the carrier includes a diffusion layer having a thickness of about 0.5 mm and distinguished by a considerable increase in hardness.

19. The method as claimed in claim 8, wherein the thickness of the metal layer is between 70 μm and 90 μm.
